(19) United States
(12) Patent Application Publication
(10) Pub. No.: US 2009/0290257 A1
(43) Pub. Date: Nov. 26, 2009

(54) MAGNETIC HEAD FOR PERPENDICULAR RECORDING AND MAGNETIC RECORDING APPARATUS

(76) Inventors: Wataru Kimura, Kanagawa (JP); Tadayuki Iwakura, Odawara (JP); Yoji Maruyama, Saitama (JP)

Correspondence Address: ZILKA-KOTAB, PC- HIT, P.O. BOX 721120, SAN JOSE, CA, 95172-1120, US

(21) Appl. No.: 12/469,291

(22) Filed: May 20, 2009

(30) Foreign Application Priority Data
May 22, 2008 (JP) 2008-134185

(51) Int. Cl. G11B 5/127

(52) U.S. Cl. 360/125.13; G9B/5.04

(57) ABSTRACT

To enable high density recording, improvements to the distribution of the magnetic field originating from a perpendicular recording magnetic head with a narrow track width, high resolution, and narrow erase width were made. According to one embodiment, a perpendicular recording magnetic head is provided with a write head which comprises a main pole layer, an auxiliary pole layer, a first subsidiary pole layer, a second subsidiary pole layer, a pedestal-like soft magnetic layer and a coil. Trailing and leading throat heights are controlled so as to make the trailing throat height shorter than the leading throat height wherein the trailing throat height is the throat height of the main pole layer's medium-tracking trailing side (top side as viewed in the film thickness direction) while the leading throat height is the throat height of the main pole layer's medium-tracking leading side (bottom side as viewed in the film thickness direction).

### RELATED APPLICATIONS

The present application claims the priority of a Japanese patent application filed May 22, 2008 under application number 2008-134185, which is incorporated herein by reference.

### BACKGROUND OF THE INVENTION

With the recent development of the information society, there has been a market desire for higher density, higher speed and smaller body magnetic recording apparatus which are represented by magnetic disk drives. As a recording method suitable to meet these market desires, perpendicular recording can be used. The perpendicular recording method is theoretically suitable for higher areal density recording. This is because raising the linear density of patterns recorded on a magnetic disk suppresses demagnetizing fields and hence results in stable magnetizations and the magnetic field originating from the write head has a smaller leakage in the cross-track direction. In addition, due to the advantage of the thermal magnetization stability of the magnetic disk, the magnetic disk is expected to realize still lower noise since the restrictions in the development of media are reduced as compared with in-plane magnetic recording media. Because of these advantages, it is plausible that magnetic disk drives will shift to the perpendicular magnetic recording method in the near future.

A perpendicular recording magnetic head is constructed by stacking a reading portion and a writing portion. The reading portion comprises a lower magnetic shield, an upper magnetic shield and a read element. The read element is sandwiched between the lower and upper magnetic shields and partially exposed to the air bearing surface. The read element is a giant magneto-resistance (GMR) effect head, a tunneling giant magneto-resistance (TMR) effect head which provides high read output, a current-perpendicular-to-plane (CPP) type GMR head which has a current directed perpendicular to the film surface, or the like. The writing portion comprises a magnetic gap, a main magnetic pole layer and a subsidiary magnetic pole layer. The magnetic gap is formed on the air bearing surface side. The main and subsidiary pole layers are coupled on the side opposite to the air bearing surface. Between the main and subsidiary pole layers, a coil is placed. In perpendicular magnetic recording, the perpendicular component of the magnetic field from the main pole layer is used for recording. Thus, a soft magnetic underlayer (SUL) is disposed below the recording layer. Due to this SUL facing the main pole layer, it is possible to generate a high magnetic field in the perpendicular direction. The magnetic flux in the SUL is returned to the magnetic head's soft magnetic layer which constitutes the subsidiary pole layer.

In perpendicular magnetic recording, writing information to the medium is compared to common stamp recording since the magnetic field distribution originating from the magnetic head is directly reflected to the magnetization pattern formed on the recording medium. Therefore, if the magnetic field distribution from the head changes due to a structural change of the head, the magnetic effective recording width, curvature of magnetization transitions, erase width, and the like, are greatly influenced. In addition, since a rotary actuator is employed in the magnetic disk drive, writing to the medium is performed at a certain skew angle depending on the radial position of the magnetic head. Therefore, the main pole layer has such an inverted trapezoidal shape that the width in the cross-track direction is narrowed toward the leading side of the running head. Further, to suppress the spread of the head magnetic field in the cross-track direction, it is useful to dispose side shields near the main pole layer as disclosed in, for example, U.S. Pat. App. 2002/0176214 and Jap. Pat. App. JP-A-2004-127480.

### SUMMARY OF THE INVENTION

To enable high density recording, improvements to the distribution of the magnetic field originating from a perpendicular recording magnetic head with a narrow track width, high resolution, and narrow erase width were made. According to one embodiment, a perpendicular recording magnetic head is provided with a write head which comprises a main pole layer, an auxiliary pole layer, a first subsidiary pole layer, a second subsidiary pole layer, a pedestal-like soft magnetic layer and a coil. Trailing and leading throat heights are controlled so as to make the trailing throat height shorter than the leading throat height wherein the trailing throat height is the throat height of the main pole layer's medium-tracking trailing side (top side as viewed in the film thickness direction) while the leading throat height is the throat height of the main pole layer's medium-tracking leading side (bottom side as viewed in the film thickness direction).

According to another embodiment, a magnetic recording drive comprises a magnetic recording medium, a medium-driving section to drive the magnetic recording medium, a magnetic head to write on the magnetic recording medium, and a head-actuating section to determine the position of the magnetic head over the magnetic recording medium. The magnetic recording medium is a perpendicular magnetic recording medium comprising a soft magnetic underlayer and a magnetic recording layer, and the magnetic head has a write head which comprises a main pole layer, a first subsidiary pole layer, and a coil, wherein the throat height of the main pole layer's medium-tracking trailing side is shorter than a leading-side throat height.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1A shows a main pole layer in a perpendicular recording magnetic head, according to one embodiment, wherein its air bearing surface portion is viewed from above in the film thickness direction.

FIG. 1B is a perspective view of the air bearing surface portion of the main pole layer in the perpendicular recording magnetic head, according to one embodiment.

FIG. 2 is a top view of the main pole layer in the perpendicular recording magnetic head, according to one embodiment.

FIG. 3 is a cross-sectional view of the perpendicular recording magnetic heads according to one embodiment.

FIG. 4A is a plan view of a magnetic disk drive having the perpendicular recording magnetic head incorporated therein, according to one embodiment.

FIG. 4B is a cross-sectional view of the magnetic disk drive having the perpendicular recording magnetic head incorporated therein, according to one embodiment.

FIG. 5 shows the effective head field distributions in the down track direction, according to one embodiment.

FIG. 6 shows the effective head field distributions in the cross track direction, according to one embodiment.

FIG. 7 shows how the maximum effective head field-obtained from down-track positions are distributed in tie cross-track direction, according to one embodiment.

FIG. 8 schematically shows magnetization patterns recorded in the medium, according to one embodiment.

FIG. 9 shows how the erase width and the effective head field are dependent on the relationship between the trailing-side throat height and the leading-side throat height, according to one embodiment.

FIG. 10 is a plan view of a variation of the main pole layer in the perpendicular recording magnetic head, according to one embodiment.

FIG. 11 is a plan view of a variation of the main pole layer in the perpendicular recording magnetic head, according to one embodiment.

FIG. 12 is a plan view of a main pole layer in a prior art perpendicular recording magnetic head.

### DETAILED DESCRIPTION

As mentioned above, in the perpendicular recording method, suitable for high density recording, the magnetic field originating from the write head is recorded on the medium like a stamp. Therefore, the magnetization pattern recorded on tie medium is determined by the magnetic field distribution which reflects the main pole layer. To make this magnetic field suitable for high density recording, the head structure has magnetic shields disposed near the main pole layer according to some embodiments. For example, a trailing shield structure, a side shield structure, and/or a wrap around shield structure may be included in the head structure. In the trailing shield structure according to one approach, a magnetic shield is disposed on the top of the main pole layer via a non-magnetic gap in order to improve the magnetic field gradient in the down-track direction. In the side shield structure according to another approach, a magnetic shield is disposed on each lateral side of the main pole layer along the down-track direction via a non-magnetic layer. The wrap around shied structure according to yet another approach has both trailing and side shields. In any of these structures, the magnetic field distribution originating from the write head is not straight along the cross track direction but curved at the track edges. Therefore, magnetization transitions recorded on the medium are curved similarly. This curvature of magnetization patterns at the track edges constitutes a large obstacle in raising track densities.

In one particularly preferred embodiment, a perpendicular recording magnetic head has a narrow track width, high recording resolution and narrow erase width that solves the problem of curvature of magnetization patterns at the track edges.

A perpendicular recording magnetic head that has a narrow track width, high recording resolution and narrow erase width that solves the problem of curvature of magnetization patterns at the track edges, according to one embodiment, is provided with a write head comprising a main pole layer, a first subsidiary pole layer and a coil, characterized in that structural control is done so that the main pole layer's top (as viewed in the film thickness direction) side, namely trailing side has a throat height shorter than that of the bottom side or leading side.

The above-mentioned throat height is defined as the length of the main pole's straight portion which extends perpendicular to the medium-facing surface with the same cross-track width as that of the medium-facing surface. It is defined as the distance from the medium-facing surface to the flared portion start point at which the cross-track width of the main pole layer begins to be widened sharply. Preferably, in some embodiments, the flared portion is flared at an angle of about 20 degrees to about 90 degrees with respect to the direction perpendicular to the medium-facing surface. According to one approach, the recording magnetic field generated from the trailing edge is higher than that from the leading edge. Thus, high field areas are shifted to the trailing side. This magnetic field distribution improves the trailing edge's magnetic field gradient in the down track direction. In addition, since the linearity of the magnetic field distribution in the cross-track direction is improved, it is possible to suppress bending of the distribution at the ambilateral ends of the track. In particular, this effect becomes apparent if the cross track width of the trailing side (top side as viewed in the film thickness direction) of the main pole layer's air bearing surface is not larger than 120 nm.

In some preferred embodiments, the trailing-side throat height of the main pole layer may be set to be about 10 nm to about 25 nm shorter than the leading-side throat height.

To prevent skew-related erasure of adjacent tracks, it is preferable that the trailing edge of the air bearing surface of the main pole layer be wider in the cross-track direction than the leading edge according to one approach. In addition, the cross track width of the main pole layer near the medium-facing surface is not constant until the flared portion is started, but may be in some other approaches. The throat may be either narrowed or widened toward the flared portion at an angle of less than 20 degrees with respect to the direction perpendicular to the medium-facing surface.

The main pole layer may have magnetic shields in the vicinity thereof in some embodiments. By employing any of the trailing shield type, side shield type and wrap around shield type, about the same magnetic shield effect can be attained.

The subsidiary pole layer may be disposed either on a leading side or a trailing side of the main pole layer in some approaches. It is also possible to employ a structure where a subsidiary pole layer is disposed on each side. The subsidiary pole layer and the auxiliary pole layer disposed adjacent to the main pole layer are magnetically coupled at the top (as viewed in the chip height direction) end. In this structure, at least one of the upper and layer subsidiary layers is coupled with the auxiliary pole layer. In addition, the subsidiary pole structure may have a pedestal-like magnetic pole on the medium-facing surface.

The coil to energize the write head may be either a helical type coil or a dual pancake type coil, according to some embodiments. The helical type has a coil wound so as to surround the auxiliary pole layer and main pole layer. The dual pancake type has pancake coils disposed respectively so as to sandwich the main pole layer and auxiliary pole layer.

It is also possible to construct a perpendicular recording read and write head by placing a read head adjacent to the write head in some approaches. The read head may be a magneto-resistance effect element sandwiched by two magnetic shields.

Another particularly preferred embodiment includes a high recording density magnetic recording apparatus (e.g., drive) by installing perpendicular recording magnetic heads with a narrow track width, high recording resolution and narrow erase width therein.

The magnetic recording drive, in one approach, comprises a magnetic recording medium, a medium-driving section to drive the magnetic recording medium, a magnetic head to write on the magnetic recording medium, and a head-actuating section to determine the position of the magnetic head over the magnetic recording medium. Also, the magnetic recording medium is a perpendicular magnetic recording medium comprising a soft magnetic underlayer and a magnetic recording layer, and the magnetic head has a write head comprising a main pole layer, a first subsidiary pole layer and a coil and the throat height of the main pole layer's medium-tracking trailing side is shorter than the leading-side throat height.

According to some embodiments, it is possible to provide a perpendicular recording magnetic head with a narrow track width, high recording resolution and narrow erase width. It is also possible to realize a high recording density magnetic recording apparatus by installing a perpendicular recording magnetic head with a narrow track width, high recording resolution and narrow erase width in the apparatus and using the apparatus with perpendicular recording magnetic media.

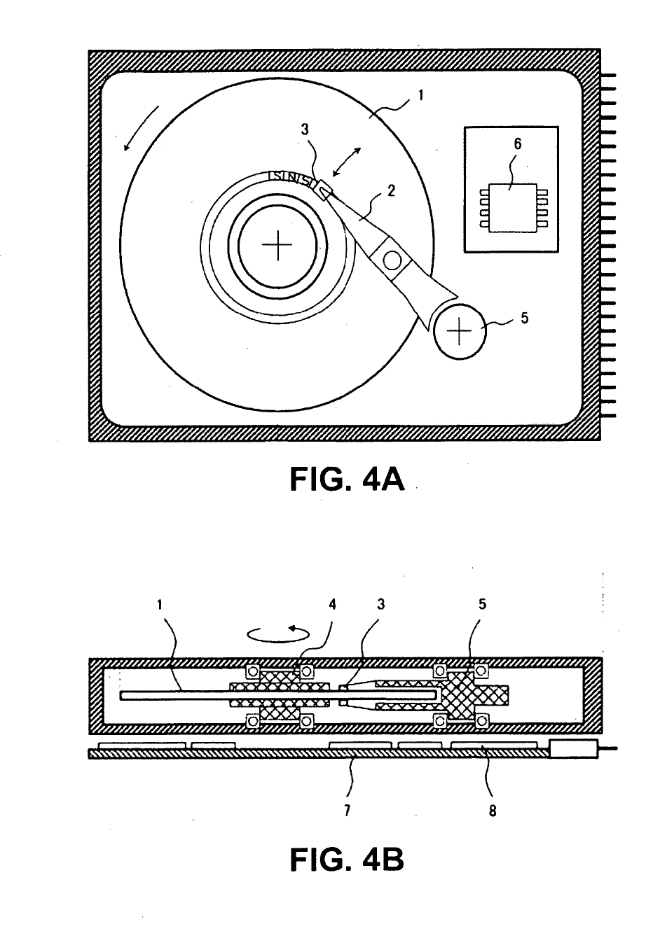

FIG. 4A and FIG. 4B illustrate the basic configuration of a magnetic disk drive (magnetic recording apparatus) using perpendicular recording technology in accordance with one embodiment. FIG. 4A and FIG. 4B are top and cross-sectional views of the drive, respectively. The magnetic disk drive comprises: a motor (medium driving member) 4, a magnetic disk (perpendicular recording medium) 1 which is driven to rotate by the directly coupled motor 4; an arm 2 supported by a rotary actuator (head actuating member) 5; and a perpendicular recording magnetic head 3 fixed at the front end of the arm 2. As the rotary actuator 5 rotates, the perpendicular recording magnetic head 3 moves over the perpendicular recording medium 1. After positioning the perpendicular recording magnetic head 3 to an arbitrary location, the magnetic information write or read function is implemented. The write signal to actuate the perpendicular recording magnetic head 3 or the read signal sent from the magnetic head is processed by a read write circuit 6 and a signal processing circuit 8 mounted on a circuit board 7.

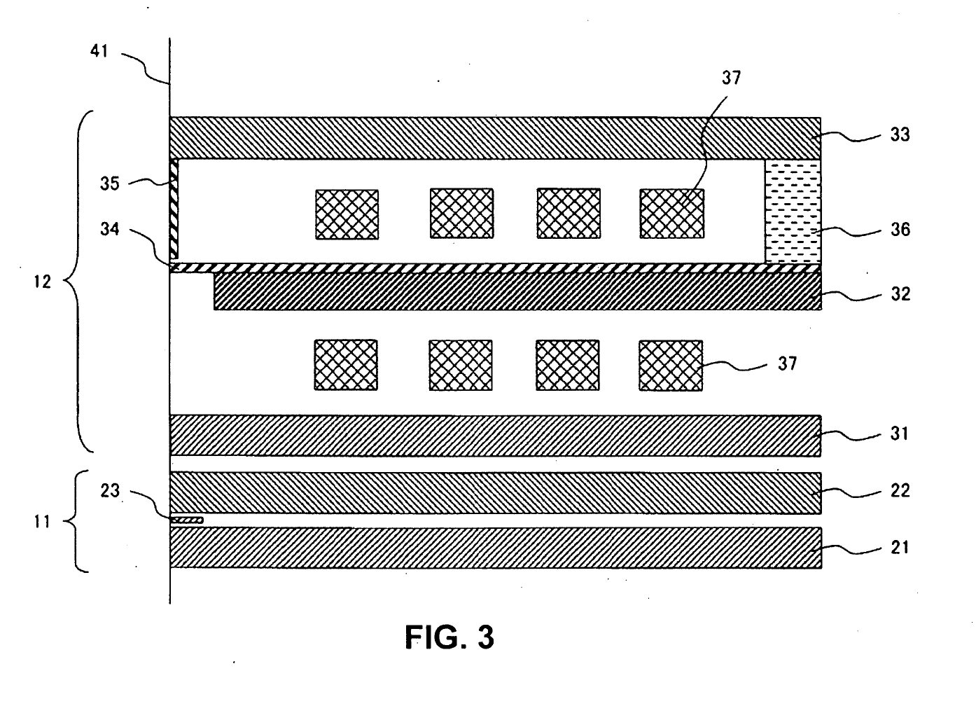

FIG. 3 is a schematic cross sectional view for illustrating the general structure of the perpendicular recording magnetic head in accordance with one embodiment. A read head 11 is a head to read information written in the recording layer of the magnetic disk. It is constructed by sandwiching a read element 23 between two magnetic shield layers 21 and 22. The read element 23 may be any type of read element, such as a giant magneto-resistance (GMR) effect sensor, a tunneling giant magneto-resistance (TMR) effect sensor, a Current-Perpendicular-to-Plane (CPP) type GMR sensor which has a current directed perpendicular to the film surface, or the like. A write head 12 is a head to generate a magnetic field for recording in the recording layer of the magnetic disk. It comprises a coil 37 and a plurality of soft magnetic layers which are surrounded above and below by the coil 37 and coupled magnetically together. The plural soft magnetic layers comprise: a first subsidiary pole layer 33; a second subsidiary pole layer 31; an auxiliary pole layer 32; a main pole layer 34 adjacent to the auxiliary pole layer 32; a back contact member 36 to magnetically couple the first subsidiary pole layer 33 and the auxiliary pole layer 32 on the side opposite to the air bearing surface 41; and a pedestal-like shield layer 35 which is disposed along the air bearing surface 41 on the trailing side of the main pole layer 34 via a non-magnetic layer. This pedestal-like shield layer 35 is magnetically coupled with the first subsidiary pole layer 33. The shape of the pedestal-like shield layer 35, viewed from the medium-facing side, may be either a trailing shield type arranged parallel to the upper side of the main pole layer 34 via a non-magnetic layer or a wrap around type which covers both upper and ambilateral sides of the main pole layer 34 via a non-magnetic layer. The main pole layer 41, viewed from the medium-facing side, has such an inverted trapezoidal shape at the air bearing surface 41 that the trailing side is longer than the leading side. The coil 37 structure may be a helical type or a pancake type according to some embodiments. In the helical structure, the coil 37 is wound around the auxiliary pole layer 34 and the main pole layer 34 adjacent thereto. In the pancake structure, the coil 37 above and below the main pole layer 34 is wound around a back contact member 36. In tie case of the pancake type coil, current for a write operation is applied antiparallelly to the respective coil conductors below and above the main pole layer 34. The auxiliary pole layer 32 disposed adjacent to the main pole layer 34 is recessed from the air bearing surface 41.

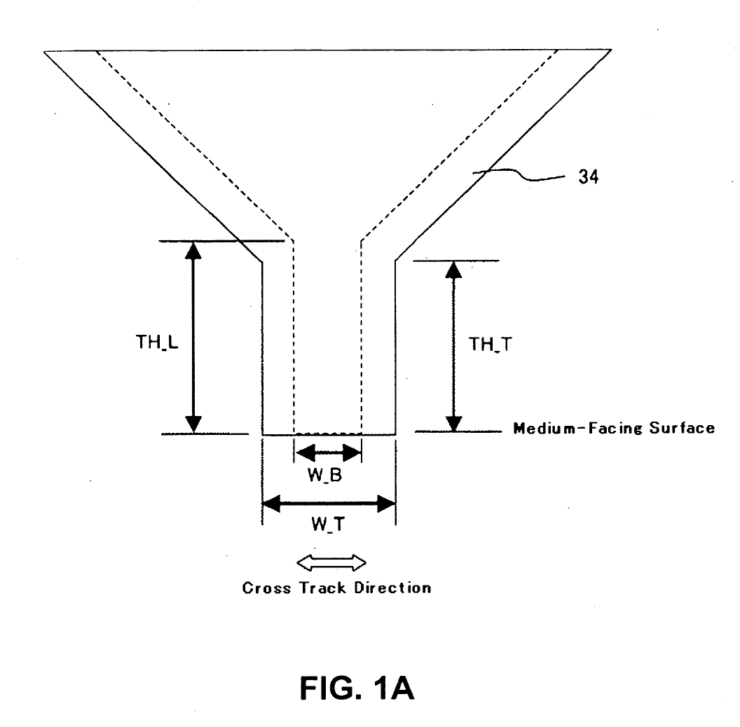

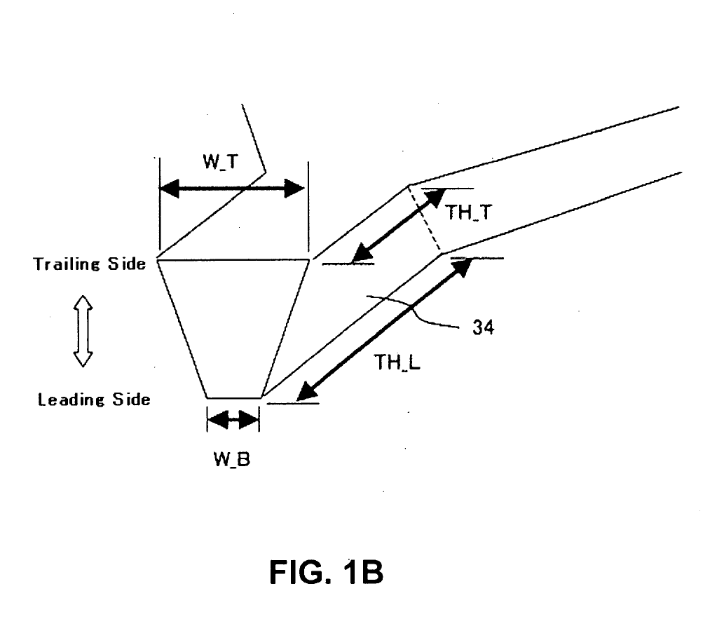

The recording track width is determined by the magnetic field which goes out from the main pole layer 34. This magnetic field, which records a magnetization pattern in the magnetic recording layer, goes through the magnetic recording layer and soft magnetic underlayer of the recording medium and forms magnetic flux passages which respectively enter the first and second subsidiary pole layers 33 and 31. The configuration of the magnetization pattern is greatly dependent on the head magnetic field distribution at the trailing edge of the main pole layer 34. Due to the relationship with the disk rotation direction, when the main pole layer 34 passes any point of the recording medium, the trailing edge is the last to pass. To realize high density recording, the magnetic field distribution at the trailing edge has high field intensity and high field gradient. Such a desirable magnetic field distribution is effectively realized if the trailing-side throat height of the main pole layer 34 is shorter than the leading-side throat height as described later with reference to FIG. 1A and FIG. 1B.

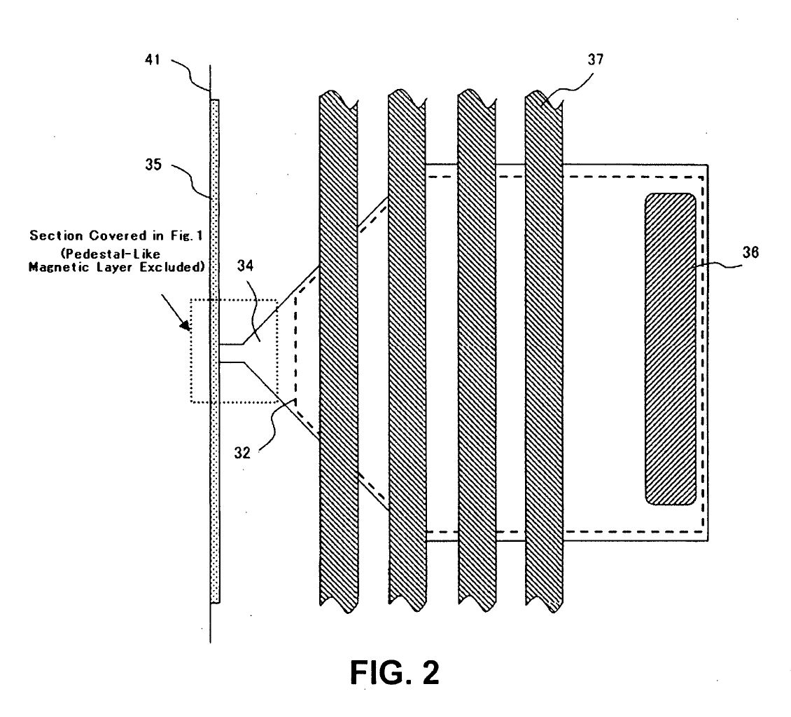

FIG. 2 is a top view of the above-mentioned main pole layer in the perpendicular recording magnetic head according to one embodiment. In FIG. 2, the first subsidiary pole layer 33, present on the top (viewed in the film thickness direction) of the main pole layer 34 is omitted. Below the main pole layer 34, the auxiliary pole layer 32 is adjacently disposed. In addition, the main pole layer 34 is connected with the first subsidiary pole layer 33 via the back contact member 36 which, viewed in the height (depth) direction of the chip, is disposed at the rear end. The coil 37 is disposed above and below so as to energize the main pole layer 34 and auxiliary pole layer 32. Along the air bearing surface 41, the pedestal-like soft magnetic layer (shield layer) 35 connected with the first subsidiary pole layer 33 is disposed on the trailing side of the main pole layer 34 via a non-magnetic layer. FIG. 1A and FIG. 1B are enlarged schematic illustrations of a portion of the main pole layer 34 which partly constitutes the air bearing surface 41 and its vicinity.

With continued reference to FIG. 1A and FIG. 1B, the following description of the shape of the main pole layer which is unique according to one embodiment. FIG. 1A is a schematic top plan view of the main pole layer in the perpendicular recording magnetic head. FIG. 1B is a perspective view of the main pole layer. The medium-facing surface of the main pole layer has such an inverted trapezoidal shape that W_B is narrower than W_T. In the film thickness direction, W_B is the width of the bottom side while W_T is the width of the top side. In the down track direction, the bottom side is the leading side while the top side is the trailing side. In the chip's height direction (depth direction) perpendicular to the medium-facing direction, the top and bottom widths W_T and W_B are kept unchanged up to the respective throat heights from which the main pole layer is widened by a certain angle. Here, the top throat height of the main pole layer is called the trailing-side throat height TH_T while the bottom throat height of the main pole layer is called the leading-side throat height TH_L. In the present embodiment, the main pole layer 34 is shaped such that the trailing-side throat height TH_T is shorter than the leading-side throat height TH_L.

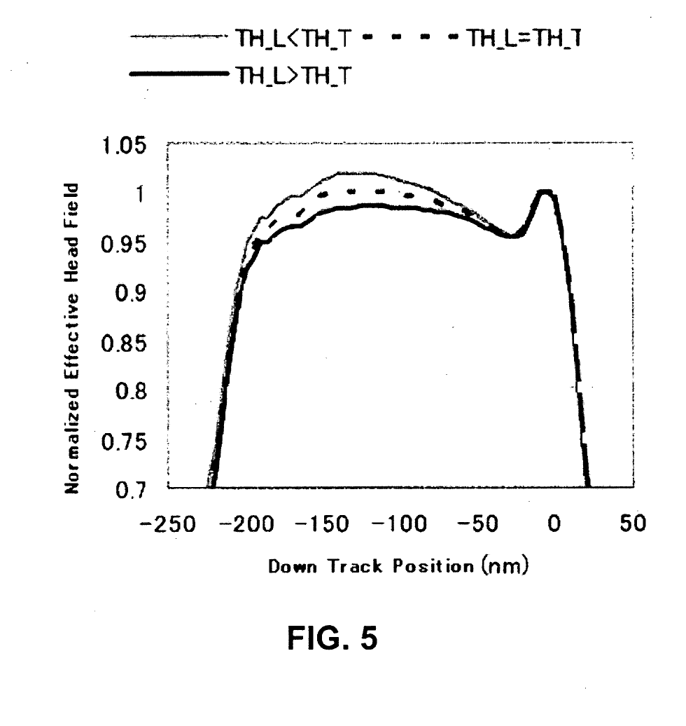

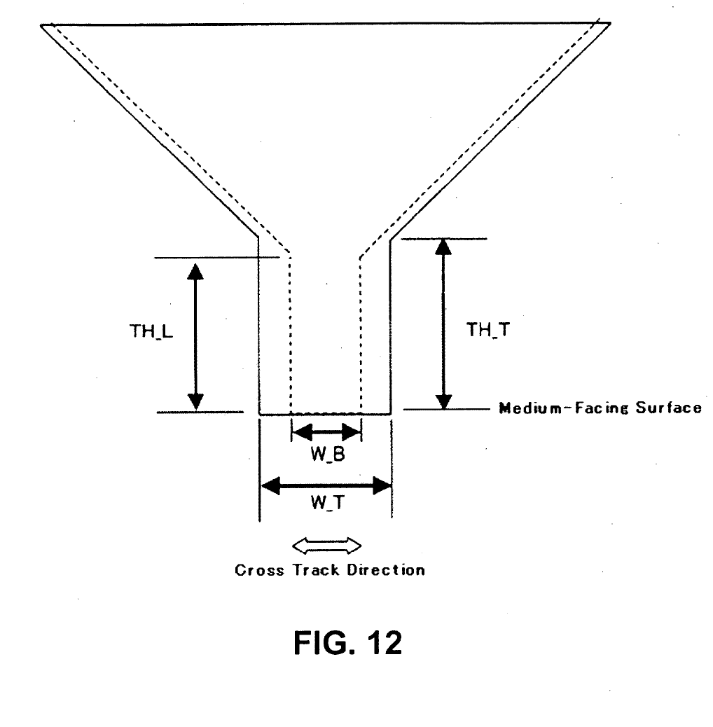

FIG. 5 shows the effective head field distributions in the down track direction, obtained by simulation for different shapes of which trailing-side throat height to leading-side throat height relations are respectively TH_L<TH_T, TH_L=TH_T and TH_L>TH_T. For each shape, the result is normalized by the magnetic field at the trailing edge. The film thickness and top height of the main pole layers used in the calculation are 200 nm and 100 nm, respectively. The difference between the trailing-side throat height TH_T and the leading-side throat height TH_L is 25 nm, approximately. Down track position zero corresponds to the top side (as viewed in the film thickness direction) of the main pole layer 34. Down track position of about 200 nm corresponds to the bottom side (as viewed in the film thickness direction) of the main pole layer 34. The distribution is such that as the position moves from the top side of the main pole layer 34 toward the bottom side, the magnetic field shows a peak, a sharp fall, a gradual re-rise and, at a position nearer to the leading edge than to the middle of the main pole layer in the film thickness direction, a peak again. The peak head field at a position nearer to the leading edge becomes larger as the ratio of the leading-side throat height TH_L to the trailing-side throat height TH_T decreases. If the trailing-side throat height TH_T is longer than the leading-side throat height TH_L as in a prior art structure shown in FIG. 12, the head field in a leading-side region is larger than the peak head field at the top of the main pole layer in the film thickness direction. Whereas the magnetic field at the trailing edge formed by the top of the main pole layer determines whether to cause a magnetic transition, such a magnetic field distribution makes the magnetic field gradient at the trailing edge less steep and lowers the linearity of the magnetic field distribution there in the cross track direction, resulting in a lowered recording resolution and an increased erase width according to some approaches.

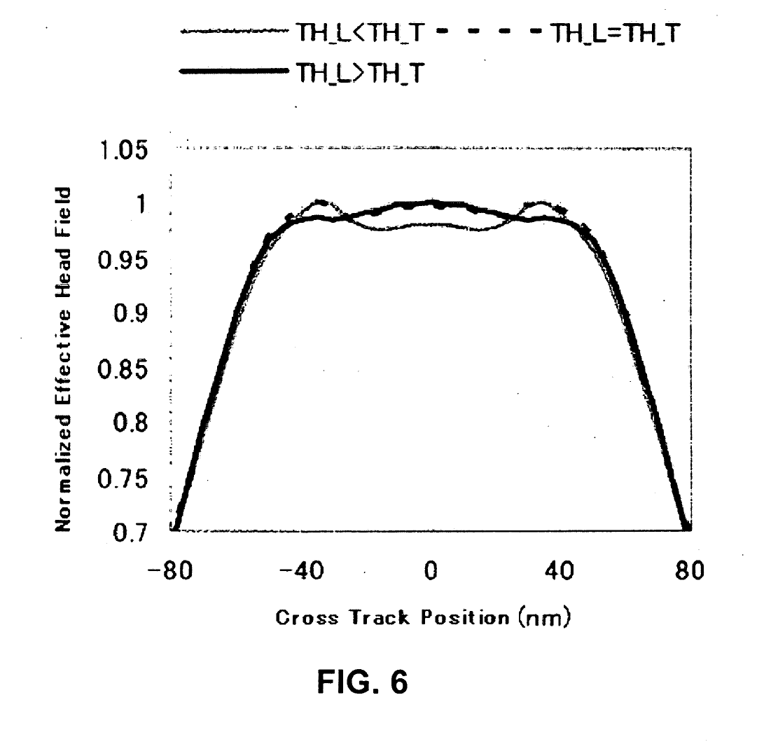

FIG. 6 shows the effective head field distributions in the cross track direction, calculated for different shapes of which trailing-side throat height to leading-side throat height relations are respectively TH_L<TH_T, TH_L=TH_T and TH_L>TH_T. For each shape, the result is normalized by the maximum effective magnetic field. The main pole layers used in the calculation are respectively the same shapes as those evaluated in FIG. 5. Cross track position 0 nm corresponds to the widthwise center of the main pole layer. In the prior art structure, where the trailing-side throat height TH_T is longer than the leading-side throat height TH_L, the maximum head field appears not at the widthwise center of the main pole layer but at positions near to the ends in the cross-track direction. In the case of the present embodiment, where the trailing-side throat height TH_T is shorter than the leading-side throat height TH_L, it is apparent that the maximum head field appears substantially at the widthwise center of the main pole layer and the magnetic field distribution is relatively flat to the ambilateral ends of the main pole layer, a desirable trait.

According to some approaches, the perpendicular recording head has such an aspect that the intensity of the produced magnetic field is very sensitive to the throat height and, as the throat height becomes shorter, the intensity of the produced magnetic field sharply increases. Thus, if the trailing-side throat height TH_T and the leading-side throat height TH_L are not the same, differences occur in the intensity of magnetic field between the top and bottom regions (as viewed in the film thickness direction) of the main pole layer 34. These effects add up and consequently change the distribution of recording magnetic field as described above.

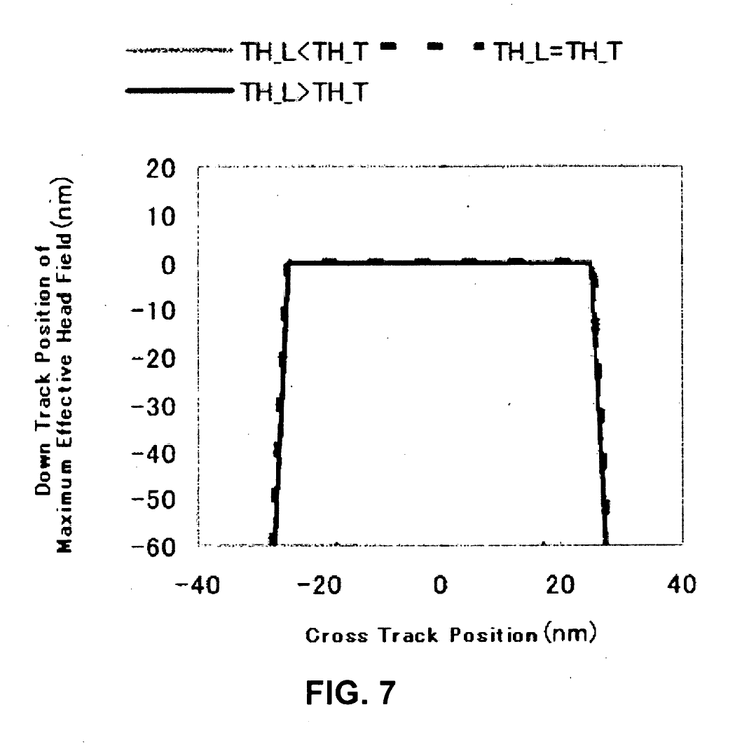

FIG. 7 shows how the down-track position, at which the maximum effective head field indicated in FIG. 6 is obtained, depends on the cross-track position, according to some approaches. In the prior art structure, where the trailing-side throat height TH_T is longer than the leading-side throat height TH_L, although the maximum head magnetic field appears in the central region of the cross-track trailing edge formed by the lop side (as viewed in the film thickness direction) of the main pole layer, this central region is as narrow as 40% of the top width of the main pole layer or less. In the case of the structure according to one embodiment, where the trailing-side throat height TH_T is shorter than the leading-side throat height TH_L, the central region of the cross-track trailing edge in which the maximum field appears is extended to larger than 50% of the top width of the main pole layer. This can greatly reduce the phase deviations of magnetization transitions recorded in the medium from the cross-track direction.

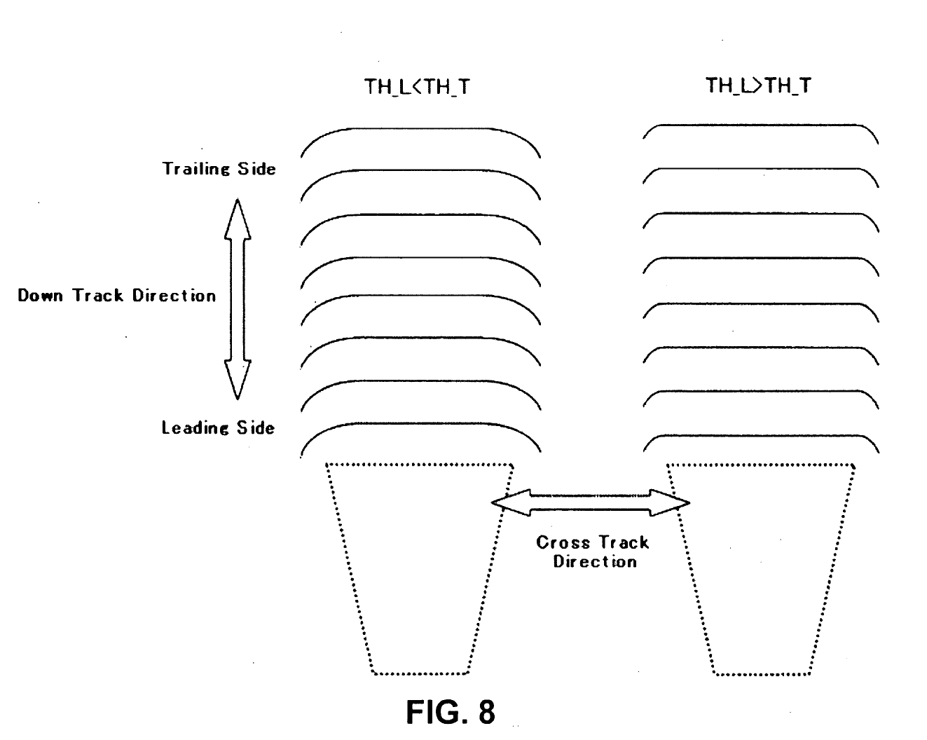

FIG. 8 shows schematic magnetization patterns recorded in the medium, according to one embodiment. In the prior art structure, where the trailing-side throat height TH_T is longer than the leading-side throat height TH_L, since magnetization transitions are greatly bent from the cross-track direction, high linear density recording causes interference between adjacent magnetization transitions, resulting in a small effective recording track width and a large erase width. In the structure according to one embodiment, where the trailing-side throat height TH_T is shorter than the leading-side throat height TH_L, magnetization transitions are not greatly bent and it is therefore possible to obtain magnetization patterns suitable for high linear density recording.

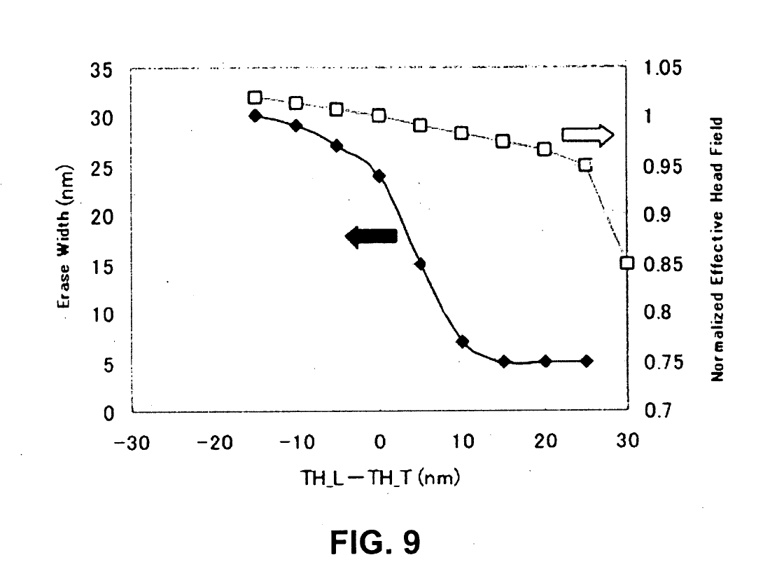

FIG. 9 shows how the erase width and the effective head field are dependent on the relation between the trailing-side throat height and the leading-side throat height, according to one embodiment. The film thickness, top width, and trailing-side throat height TH_T of the main pole layer used in the calculation are fixed respectively to 200 nm, 100 nm, and 100 nm whereas the leading-side throat height TH_L is varied. In the prior art structure, where the leading-side throat height TH_L is shorter than the trailing-side throat height TH_T, the erase width is as large as 25 nm to 30 nm. In the case of the structure according to one embodiment, where the leading-side throat height TH_L is longer than the trailing-side throat height TH_T, the erase width sharply decreases to about 5 nm as the throat height difference increases to +10 nm. Beyond +10 nm, the erase width is almost constant although the throat height difference is increased to +25 nm.

By contrast, the effective head field decreases gradually and monotonously as the leading-side throat height TH_L increases. However, the pace of decrease becomes larger as the throat height difference approaches +30 nm. This may result in poor recording capability. Due to this dependence of the head field on the trailing-side and leading-side throat heights, it is desirable to make the trailing-side throat height shorter than the leading-side throat height by about 10 nm to about 25 nm.

As compared with the prior art technology, the structure, according to some embodiments, is very effective for realizing narrow track width, high recording resolution, and narrow erase width since it is possible to greatly improve the head field distribution by making the trailing-side throat height TH_T of the main pole layer 34 shorter than the leading-side throat height TH_L. In addition, since the phase deviation of the head field distribution from the cross-track direction can be reduced, it is possible to contribute toward higher linear density recording by improving the linearity of magnetization transitions, according to some approaches.

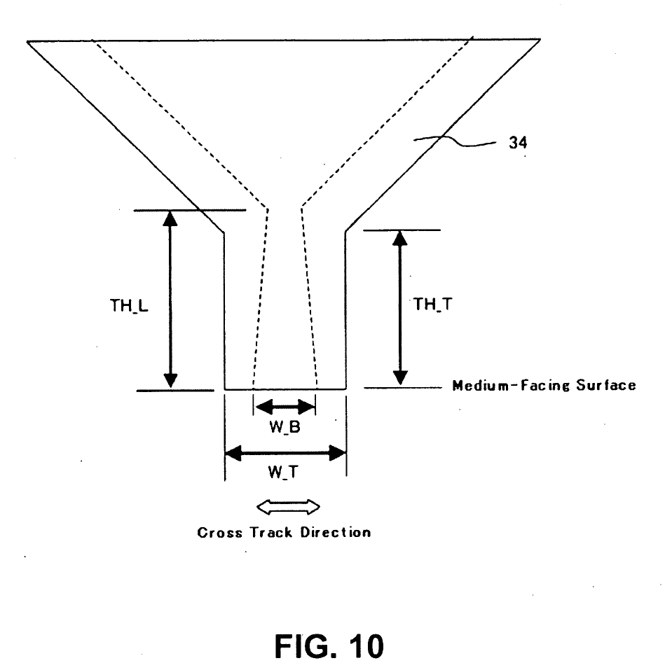

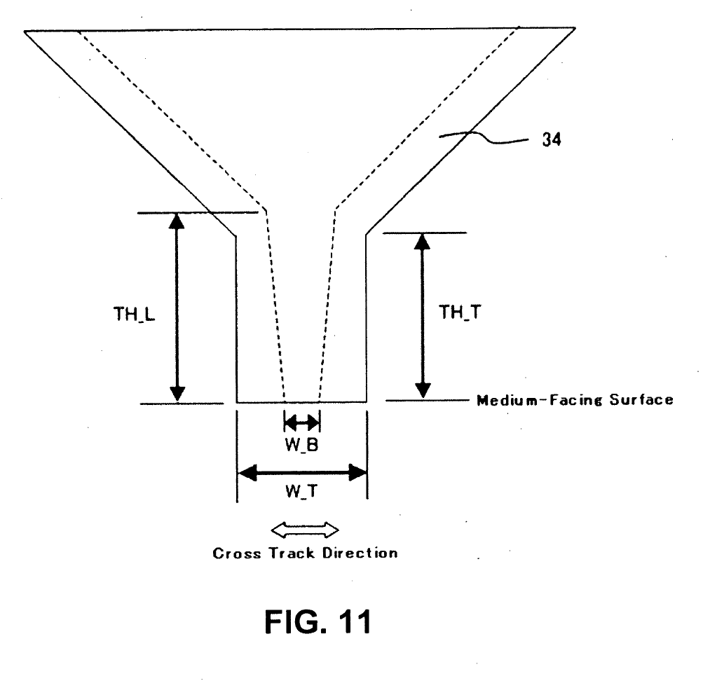

FIG. 10 and FIG. 11 show embodiments of the write head structure. The width of the bottom (as viewed in the film thickness direction) of the main pole layer 34 is not constant in the chip height direction, but it may be constant in some embodiments. The width may be either narrowed or widened as the distance from the medium-facing surface increases. However, it is desirable to make this angle smaller than ±20 degrees with respect to the direction perpendicular to the medium-facing surface.

FIG. 12 is a schematic plan view of a main pole layer in a prior art perpendicular recording magnetic head. Since the track width portion of the main pole layer is shaped by ion milling, the top side (as viewed in the film thickness direction), namely the trailing side of the main pole layer, is more recessed by milling. Consequently, the trailing-side throat height TH_T of the main pole layer becomes longer than the leading-side throat height TH_L. In the case of the structure according to one embodiment, the incidence angle of ions to the film surface is set smaller or the incident direction of ions is limited when the main pole layer 34 is shaped by ion milling. By applying such an improved process, it is possible to make the trailing-side throat height TH_T shorter than the leading-side throat height TH_L.

By incorporating the above-mentioned perpendicular recording magnetic head embodiments in a magnetic disk drive shown in FIG. 4A, it is possible to realize high density recording.

What is claimed is:

1. A perpendicular recording magnetic head provided with a write head comprising:
a main pole layer;
a first subsidiary pole layer and a coil, wherein the throat height of the main pole layer's medium-tracking trailing side is shorter than the leading-side throat height.

2. A perpendicular recording magnetic head in accordance with claim 1, wherein the throat heights of the main pole layer are measured in the depth direction from the medium-facing surface to flared portion start points at which the cross-track width of the main pole layer begins to be widened.

3. A perpendicular recording magnetic head in accordance with claim 1, wherein the trailing-side throat height of the main pole layer is about 10 nm to about 25 nm shorter than the leading-side throat height.

4. A perpendicular recording magnetic head in accordance with claim 1, wherein the medium-facing surface of the main pole layer has such a shape that the cross-track width of the leading edge is narrower than the cross-track width of the trailing edge.

5. A perpendicular recording magnetic head in accordance with claim 1, wherein the medium-facing surface of the main pole layer has such an inverted trapezoidal shape that the leading edge is narrower than the trailing edge.

6. A perpendicular recording magnetic head in accordance with claim 2, wherein the leading-side cross-track width of the main pole layer is narrowed from the medium-facing surface toward the flared portion start point at an angle of less than 20 degrees with respect to the direction perpendicular to the medium-facing surface.

7. A perpendicular recording magnetic head in accordance with claim 2, wherein the leading-side cross-track width of the main pole layer is widened from the medium-facing surface toward the flared portion start point at an angle of less than 20 degrees with respect to the direction perpendicular to the medium-facing surface.

8. A perpendicular recording magnetic head in accordance with claim 2, wherein the cross-track width of the main pole layer begins to be widened at the flared portion start points at an angle of 20 to 90 degrees with respect to the direction perpendicular to the medium-facing surface.

9. A perpendicular recording magnetic head in accordance with claim 1, wherein a soft magnetic layer is disposed on the trailing side of the main pole layer via a non-magnetic layer.

10. A perpendicular recording magnetic head in accordance with claim 1, wherein a soft magnetic layer is disposed on each of the trailing side and ambilateral sides of the main pole layer via a non-magnetic layer.

11. A perpendicular recording magnetic head in accordance with claim 1, wherein the perpendicular recording magnetic head includes a read head comprising a magneto-resistance effect element which is disposed adjacent to the write head and sandwiched by two magnetic shield layers.

12. A perpendicular recording magnetic head in accordance with claim 11, wherein the write head has a second subsidiary pole on a read head side.

13. A magnetic recording drive comprising:
a magnetic recording medium;
a medium-driving section to drive the magnetic recording medium;
a magnetic head to write on the magnetic recording medium; and
a head-actuating section to determine the position of the magnetic head over the magnetic recording medium,
wherein the magnetic recording medium is a perpendicular magnetic recording medium comprising a soft magnetic underlayer and a magnetic recording layer,
wherein the magnetic head has a write head comprising:
a main pole layer;
a first subsidiary pole layer; and
a coil,
wherein the throat height of the main pole layer's medium-tracking trailing side is shorter than a leading-side throat height.

14. A magnetic recording drive in accordance with claim 13, wherein the trailing-side throat height of the main pole layer is about 10 nm to about 25 nm shorter than the leading-side throat height.

15. A magnetic recording drive in accordance with claim 13, wherein a medium-facing surface of the main pole layer has such a shape that a cross-track width of the leading edge is narrower than the cross-track width of the trailing edge.

16. A magnetic recording drive in accordance with claim 13, wherein a leading-side cross-track width of the main pole layer is narrowed from a medium-facing surface toward the flared portion start point at an angle of less than 20 degrees with respect to a direction perpendicular to the medium-facing surface.

17. A magnetic recording drive in accordance with claim 13, wherein a leading-side cross-track width of the main pole layer is widened from a medium-facing surface toward the flared portion start point at an angle of less than 20 degrees with respect to a direction perpendicular to the medium-facing surface.

18. A magnetic recording drive in accordance with claim 13, wherein a soft magnetic layer is disposed on the trailing side of the main pole layer via a non-magnetic layer.

19. A magnetic recording drive in accordance with claim 13, wherein a soft magnetic layer is disposed on each of the trailing side and ambilateral sides of the main pole layer via a non-magnetic layer.

20. A magnetic recording drive in accordance with claim 13, wherein there is provided a read head comprising a magneto-resistance effect element which is disposed adjacent to the write head and sandwiched by two magnetic shield layers.
